(19) United States
(12) Patent Application Publication
(10) Pub. No.: US 2020/0310897 A1
(43) Pub. Date: Oct. 1, 2020

(54) AUTOMATIC OPTIMIZATION FAULT FEATURE GENERATION METHOD

(71) Applicant: Marketech International Corp., Taipei (TW)

(72) Inventors: Chien-Ming Martin Wei, Taipei (TW); Yu-Jen Wang, Taipei (TW); Hao-Yen Chang, Hsinchu (TW)

(21) Appl. No.: 16/367,680

(22) Filed: Mar. 28, 2019

(51) Int. Cl. G06F 11/07; G06F 17/50; G06N 20/00

(52) U.S. Cl. CPC G06F 11/079; G06F 11/0736; G06F 2217/16; G06F 17/5009; G06N 20/00; G06F 11/0751

(57) ABSTRACT

The present invention provides an automatic optimization fault feature generation method, an optimized versatile fault feature can be automatically generated through a procedure of the present invention, and the fault feature can be provided for various fault prediction models to reduce data pre-processing time and new model development costs.

### FIELD OF THE INVENTION

The present invention relates to a method for generating fault features, and more particularly to a method for automatically generating fault features that are optimal and versatile for various fault prediction models.

### BACKGROUND OF THE INVENTION

Industry 4.0 has swept like a storm, every place of the world is full of enthusiasm in this trend, and the relevant companies in various fields are ready and working hard to invest a large amount of resources in an attempt to develop intergenerational products, and look forward to becoming a pioneer to ride the wave in this era. Industry 4.0 is overthrowing our dependence on the past; it is subverting our definition of modernity; and it is fulfilling our hopes for the future.

Industry 4.0 does not deviate from a core concept—“smart”, but in different fields, relatively speaking, smart has different interpretations. Among them, the manufacturer's explanation is “fully unmanned, fully automated”, which means that manufacturers expect to complete the full automated production line in Industry 4.0. The blueprint for the future of the manufacturers is a magnificent scene of a large fully mechanically controlled plant. However, there is still an insurmountable problem to be solved to achieve complete unmannedness, that is equipment monitoring and troubleshooting, and it is difficult to completely remove human intervention in this stage. Manufacturers are still working hard to develop methods for monitoring and troubleshooting related equipment in an attempt to get rid of this bottleneck.

In today's equipment monitoring, critical parameters (CP) are often used with the aid of associated parameters (AP) to determine the health status of equipment and to establish fault prediction models. For example, in a model for dynamically updating and predicting systems and processes disclosed in the US patent application No. US 2016/0350671 A1, the application is characterized by data acquired by a plurality of sensors, responding to dynamic changes in the environment or monitoring data during operation, and dynamically updating to generate new probabilistic models, and the probabilistic model that has been replaced by the subsequently generated probabilistic model can be removed from the probabilistic models currently in use.

However, it is often impossible to fully and effectively interpret the health status of an equipment based on a single critical parameter, and assistance with other associated parameters is required at this time. Currently, there is no effective or versatile method for choosing which associated parameters and how many associated parameters to be used.

In addition, prediction model development requires extremely high costs. Critical parameters of different equipment are often inconsistent or even critical parameters of the same type of parts are different. The solution is often to replace with a new prediction model, or to develop a new prediction model, or to make significant modification to the original model, but in these ways, more resources have to be invested to achieve the goal of fault prediction.

Therefore, there is still much room for improvement in the fault prediction model and associated fault feature generation methods.

### SUMMARY OF THE INVENTION

One object of the present invention is to solve the problem that in the past, when the predicted target equipment is replaced, the lack of critical parameters or critical parameters are not applicable to the existing fault prediction model, resulting in the need to modify or even re-develop the original fault prediction model, and resulting in waste of costs.

Another object of the present invention is to provide a fault feature that is highly stable and versatile and suitable for use in most of the existing fault prediction models.

In order to achieve the above objects, the present invention provides an automatic optimization fault feature generation method, comprising the following steps of:

step S1: screening a plurality of data out from a plurality of initial data collected and stored by at least one sensing collector to form a training parameter database and a testing parameter database;

step S2: respectively dividing the plurality of data included in the training parameter database and the testing parameter database into a critical parameter and an associated parameter candidate set comprising parameters other than the critical parameter, and then identifying a plurality of associated parameters leading the critical parameter from the associated parameter candidate set, and sorting the plurality of associated parameters from a first associated parameter to an nth associated parameter according to a leading degree, wherein n is a positive integer; and

step S3: combining the critical parameter with one or more of the plurality of associated parameters from the training parameter database and the testing parameter database respectively to form at least one training independent variable data and at least one testing independent variable data, and composing at least one fault feature from the at least one training independent variable data and a fault flag by using a generalized linear model.

In one embodiment, the step S3 further comprising: constructing and generating weights of the critical parameter and the plurality of associated parameters in the at least one training independent variable data according to the plurality of data included in the training parameter database.

In one embodiment, after the step S3, further comprising a step S4, analyzing the at least one testing independent variable data by a classification method to evaluate an accuracy of the at least one fault feature.

In one embodiment, the generalized linear model is a logistic regression model.

In one embodiment, each of the plurality of initial data in the step S1 is a cycle data having a record from installation to fault occurrence.

In one embodiment, the fault flag is a normal operation or a fault record generated at a time point.

In one embodiment, the at least one fault feature is a probability value between 0% and 100%.

The present invention further provides an automatically optimized fault feature generation method, comprising the following steps of:

collecting a plurality of initial data having a cycle data by at least one sensing collector to form an initial database having a plurality of data, and dividing the plurality of data into a training data set and a testing data set according to the cycle data;

screening the training data set and the testing data set by a feature extraction algorithm to form a training parameter database and a testing parameter database;

dividing the plurality of data included in the training parameter database and the testing parameter database respectively into a critical parameter set including at least one critical parameter and an associated parameter candidate set comprising parameters other than the at least one critical parameter;

identifying a plurality of associated parameters leading the at least one critical parameter from the associated parameter candidate set to form an associated parameter set;

sorting the plurality of associated parameters of the associated parameter set according to a leading degree to obtain a sorted associated parameter set; and

composing a fault feature with a fault flag, the critical parameter set and the sorted associated parameter set by using a generalized linear model.

In one embodiment, after composing the fault feature, further performing a classification accuracy evaluation to verify an accuracy of the fault feature.

In summary, the fault feature can be automatically generated by the present invention, and the versatility is applicable to multiple fault prediction models, and the impact of critical parameter changes on the existing fault prediction models can be reduced. According to the present invention, it can provide more complete fault information than simply using critical parameters, and can improve the prediction accuracy of the existing model prediction.

In addition, the present invention is suitable for use in a variety of models, and there is no need to modify or develop new models as the fault prediction models in the prior art have to adapt to different equipment. The present invention has higher stability and versatility than the conventional techniques, and can avoid the problem of modifying or replacing the existing prediction models due to equipment replacement.

### BRIEF DESCRIPTION OF THE DRAWINGS

FIG. 1 is a procedure diagram of a fault feature generation method according to an embodiment of the present invention;

FIG. 2 is a flowchart of the fault feature generation method according to an embodiment of the present invention; and

FIG. 3 is a flowchart of generating an associated parameter set after sorting according to an embodiment of the present invention.

### DETAILED DESCRIPTION OF THE PREFERRED EMBODIMENTS

The detailed description and technical content of the present invention will now be described with reference to the accompanying drawings as follows:

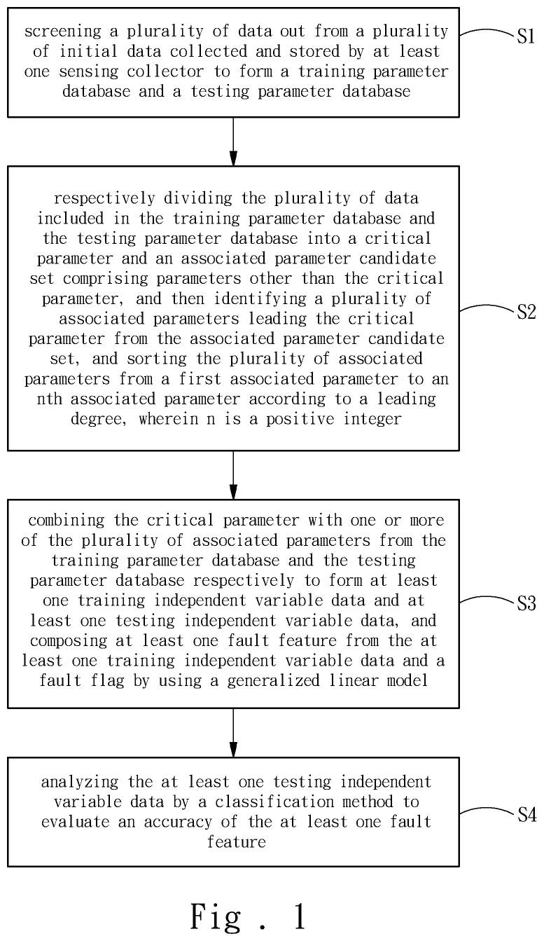

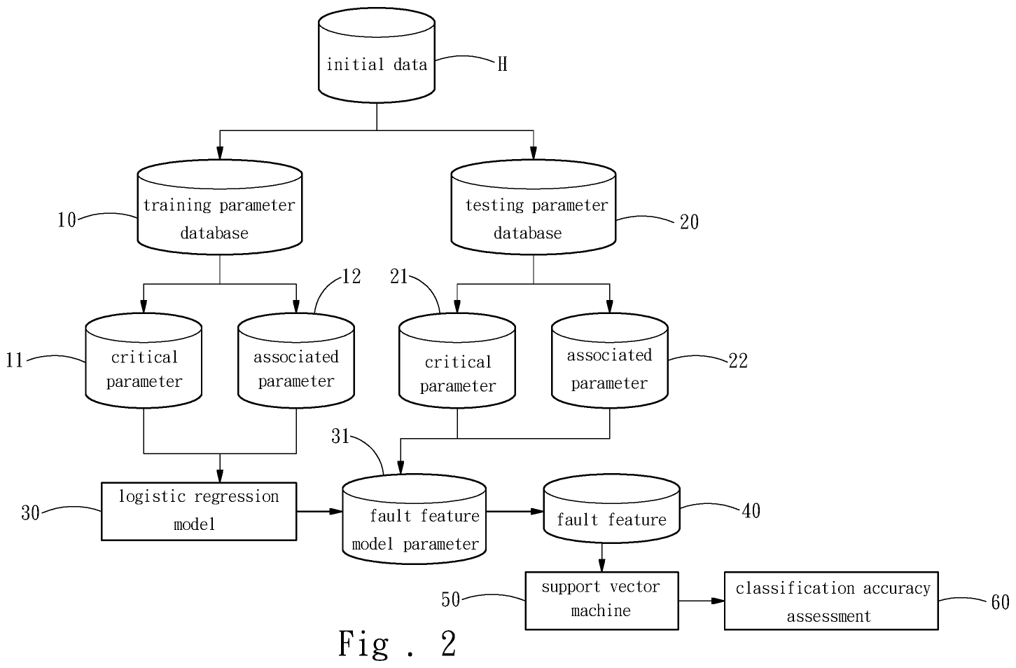

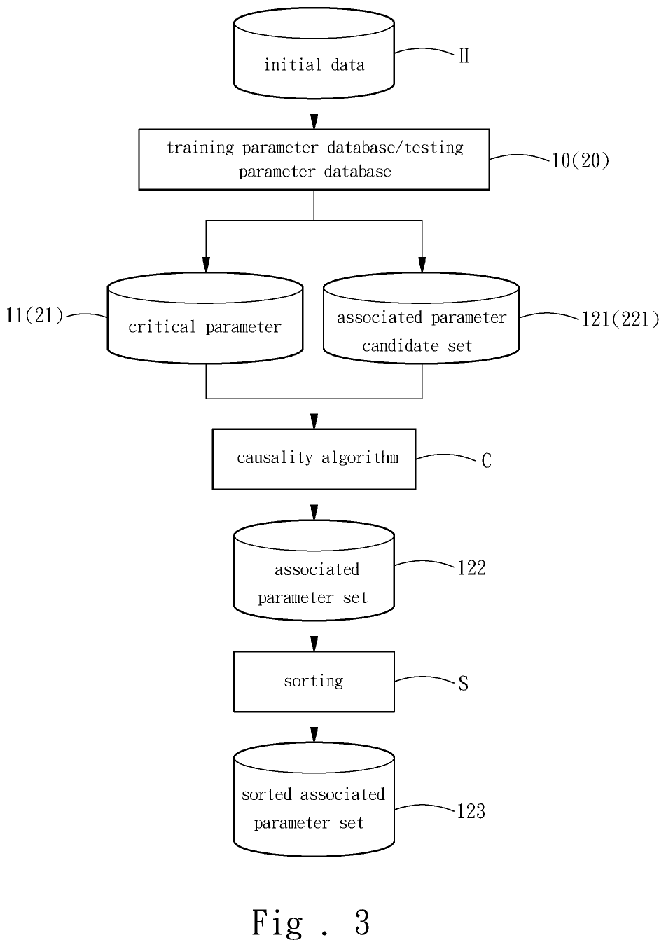

Please refer to FIG. 1, FIG. 2, and FIG. 3, which are respectively a procedure diagram of a fault feature generation method, a flowchart of the fault feature generation method, and a flowchart of generating an associated parameter set after sorting according to an embodiment of the present invention.

First, in step S1, collecting and storing a plurality of initial data H in a storage space by using at least one sensing collector, and screening a plurality of data out from the plurality of initial data H and classifying into a training parameter database 10 and a testing parameter database 20.

In detail, in the step S1, a plurality of sensing collectors collects and stores a plurality of initial data H having a cycle data, and forms an initial database having the plurality of data. The plurality of initial data H are randomly divided into a training data set and a testing data set according to the cycle data. The “cycle data” described herein refers to a record generated during a period from the installation to the occurrence of a fault of a device or a part. The training data set and the testing data set are screened by a feature extraction algorithm to form the training parameter database 10 and the testing parameter database 20.

There is no particular limitation on the method of screening the data by using the feature extraction algorithm. For example, the method described in the content in the U.S. patent application Ser. No. 16/001,520 can be used for screening, but other methods are also applicable.

In step S2, the present embodiment mainly uses the training parameter database 10 for description, and the testing parameter database 20 is also applicable to the following processing method. In the step S2, dividing the plurality of data included in the training parameter database 10 (or the testing parameter database 20) into a critical parameter (CP) 11 (21) and an associated parameter candidate set 121 (221) comprising parameters other than the critical parameter 11 (21), and then identifying a plurality of associated parameters (AP) 12 leading the critical parameter 11 (21) from the associated parameter candidate set 121 (221), and sorting the plurality of associated parameters 12 from a first associated parameter AP⁽¹⁾ to an nth associated parameter AP⁽ⁿ⁾ according to a leading degree, wherein n is a positive integer. As supplementary explanation, the so-called “critical parameter 11 (21)” refers to a factor most relevant to equipment fault; for example, it can be temperature, electric current, voltage, etc., be defined by any technicians skilled in the art, be compared with any conventional mathematical models (such as correlation model) as a selection reference, or can be a factor that is conventionally most relevant to the fault of a target monitoring device, and is not limited thereto. In this embodiment, the critical parameter 11 (21) is defined by a user. In addition, an amount of the critical parameter 11 (21) is not limited and can be modified by person skilled in the art, that is, one or more critical parameters in the invention are allowable.

In detail, in the step S2, the plurality of data which are respectively included in the training parameter database 10 and the testing parameter database 20 are divided into a critical parameter set including the at least one critical parameter 11 (21) and the associated parameter candidate set 121 (221) including parameters other than the critical parameter 11 (21).

Subsequently, a plurality of associated parameters 12 which are leading the critical parameter 11 is identified from the associated parameter candidate set 121 by a causality algorithm C to form an associated parameter set 122.

Next, the plurality of associated parameters 12 of the associated parameter set 122 are performed with a sorting S according to the leading degree to obtain a sorted associated parameter set 123. The leading degree is a first appearance time comparison of the associated parameter 12 causing the reaction of the critical parameter 11. The so-called “first appearance time comparison”, for example, the first associated parameter AP⁽¹⁾ is the associated parameter 12 being relatively the earliest to cause the critical parameter 11 to react on a time axis, so it is the first in the sequence, and the last is the nth associated parameter AP⁽ⁿ⁾ as arranged sequentially.

In order to make the person having ordinary skill in the art better understand the present invention, the operation of the causality algorithm C is described below, and please refer to FIG. 2 and FIG. 3.

First, an autoregression model (AR model) of the critical parameter 11 is established by using the set of the critical parameters 11 and the associated parameter candidate set 121 in the training parameter database 10, as equation (1) below:

CPₜ=CPₜ₋₁+ . . . +CPₜ₋ₘ+errorₜ (1)

wherein CPₜ represents an observed value of the critical parameter 11 at time t, and according to the F-test, if an explanatory power of the autoregression model can be improved when a lag period of the critical parameter 11 at time t added to the autoregression model, the lag period will be left in the autoregression model; wherein in represents a variable lag period of the critical parameter 11 being tested as the earliest one on a time axis, and errorₜ is an estimated error.

Adding the lag period of the associated parameter 12 to establish autoregression model as equation (2) below:

CPₜ=CPₜ₋₁+ . . . +CPₜ₋ₘ+APₜ₋ₚ+APₜ₋ₚ₋₁+ . . . +AP_{t-q}+errorₜ (2)

Similarly, according to the F-test, if an explanatory power of the autoregression model can be improved when a lag period of the associated parameter 12 at time t added to the autoregression model, and the lag period will be left in the autoregression model. p represents a variable lag period of the associated parameter 12 being tested as the earliest one significantly on a time axis, and q represents a variable lag period of the associated parameter 12 being tested as the most recent one significantly on a time axis.

The null hypothesis of the F-test is: “the associated parameter 12 is not the Granger causality of the critical parameter 11”. If no lag period of the associated parameter 12 is left in the model, the null hypothesis without the Granger causality is established.

If the associated parameter 12 Granger-cause the critical parameter 11, the associated parameter 12 is included in the associated parameter set 122, and this step is repeated n times, once for each of all parameters that can be collected, wherein n is a quantity of the associated parameters 12. The associated parameters 12 are then sorted from the earliest to the latest according to the leading degree to form the sorted associated parameter set 123, which can be marked as {AP⁽¹⁾, AP⁽²⁾, . . . , AP⁽ⁿ⁾}, wherein AP⁽¹⁾ is the associated parameter 12 being the earliest leading of the critical parameter 11 to react, that is, the associated parameter 12 being the earliest to cause the critical parameter 11 to react, AP⁽²⁾ is the second, and so on to AP⁽ⁿ⁾.

Next, in step S3, starting from the associated parameter AP⁽¹⁾ with the highest leading degree, combining the critical parameter 11 of training parameter database 10 with one or more of the plurality of the associated parameters 12 to form combinations of training independent variable data such as {CP, AP⁽¹⁾}, {CP, AP⁽¹⁾, AP⁽²⁾}, {CP, AP⁽¹⁾, AP⁽²⁾, AP⁽³⁾}, and the like. Similarly, combining the critical parameter 21 of the testing parameter database 20 with the associated parameter 22 in the same combination method as for the training independent variable data to form at least one testing independent variable data.

Further in the step S3, constructing and generating weights of the critical parameter 11 and the associated parameters 12 in the training independent variable data according to the data in the training parameter database 10. For example, a new fault feature 40 is composed of {a₁ times of CP, b₁ times of AP⁽¹⁾, b₂ times of AP⁽²⁾, . . . , and bₙ times of AP⁽ⁿ⁾}, so it can be interpreted that the training data set is used to determine the weights of the critical parameter 11 and the associated parameters 12 respectively, thereby generating a fault feature model parameter 31 (a₁ times, b₂ times . . . bₙ times). The training independent variable data including the fault feature model parameter 31 described above is subsequently used as a variable set including a plurality of variables X for composing the fault feature 40. In order for the fault feature 40 to be composed subsequently to include more fault prediction information and to be more versatile, a fault flag is further used as another variable Y for composing the fault feature 40. The above-mentioned “fault flag” refers to a normal operation or a fault record generated by a device at a time point. For example, when the device is operating normally at a certain point in time, it is recorded as “normal operation”; and if an abnormality or a fault occurs, it is recorded as “fault”.

The present invention uses a generalized linear model such as a logistic regression model 30 to compose the new fault feature 40. The aforementioned {CP, AP⁽¹⁾}, {CP, AP⁽¹⁾, AP⁽²⁾}, . . . , {CP, AP⁽¹⁾, . . . , AP⁽ⁿ⁾}, are used as an independent variable set, the fault flag can be a binary dependent variable Y, that is Y˜B (1, π(x)), wherein π(x)=P(Y=1|X=x) is a probability of Y=1 when X=x. The fault flag is, as described previously, recorded as Y=0 when a condition of the device at a certain point in time is the normal operation; or recorded as Y=1 when the condition is the fault record. Therefore, π(x) can be regarded as the probability of fault. The logistic regression model 30 assumes that the relationship between the probability of fault π(x) and x is as equation (3) and equation (4) below:

log(π(x)/(1−π(x)))=α+βx (3)

π(x)=exp(α+βx)/(1+exp(α+βx)) (4)

wherein π(x)/(1−π(x)) is an odds ratio, the transformation of odds ratio to logarithmic values is called logit transformation, and the logit function α+βx=log(μ/(1−μ)), is called the link function of logistic regression.

The resulting fault feature 40 is a probability value between 0% and 100%, and therefore, the resulting fault feature 40 can also be regarded a probability of fault.

The present invention adopts the logistic regression method, combines the critical parameter 11, the associated parameter 12, and the fault flag to generate the new fault feature 40. Therefore, the fault feature 40 includes more fault prediction information and is more versatile.

However, a quantity of the associated parameters 12 added to the composition is not the more the better, adding too many of the associated parameters 12 may interfere with the accuracy, and adding too few may cause the included fault information to be easily insufficient. Therefore, after the step S3, the present invention further comprises a step S4. In the step S4, analyzing the at least one testing independent variable data by a classification method to evaluate an accuracy of the fault feature 40, that is, providing a procedure for selecting a quantity of the associated parameters 12, capable of automatically determining a quantity of the associated parameters 12. Through a simple classifier, such as a linear classifier, a support vector machine (SVM) 50 is used in this embodiment to perform a classification accuracy assessment 60 with real faults. As supplementary explanation, the so-called “real faults” are actual fault records. The support vector machine 50 will generate unreal faults, and the “unreal faults” are a set of fault information determined by models (non-real faults), and the accuracy is obtained by comparing the fault information with the real faults.

The purpose of the support vector machine 50 is to find a hyperplane that separates two different sets. Accordingly, a line can be found to separate the normal data set from the fault data set, and the larger of the distance between the line and the margins of the two sets, the better, in order to distinguish.

The mathematical expression of the support vector machine 50 is as follows, assuming the parameters of the device and the fault flag set {xᵢ, yᵢ}, i=1, . . . , txᵢ ∈R^{d}, yᵢ∈{−1, +1}, wherein xᵢ is the parameter of the device at the time point i, yᵢ is the fault flag of the device at the time point i, at an occurrence of an corresponding fault event, the fault flag is recorded as yᵢ=−1, when the device is in a normal state, the fault flag is recorded as yᵢ=+1. The idea of the support vector machine 50 identification method is to find a straight line f(x)=w^{T}x−b so that all the yᵢ=−1 points fall on the side of f(x)<0, and all the yᵢ=+1 points fall on the side of f(x)>0. With this method, sets of data can be divided into a normal state or a fault state by a positive or negative sign. The parameter estimation of f(x) can be performed by the Lagrange multiplier method, but is not limited thereto.

As described above, after causing the training data set to construct and generate the weights of the critical parameter 11 and the associated parameters 12 in the training independent variable data by using the aforementioned method, the data in the testing parameter database 20 is formed into a plurality of the testing independent variable data according to the weights and compositions of the critical parameter 11 and the associated parameters 12 generated by the training parameter database 10. Afterwards, the support vector machine 50 is used to verify the accuracy of the new fault feature 40 generated by the testing independent variable data ({CP, AP⁽¹⁾}, {CP, AP⁽¹⁾, AP⁽²⁾}, . . . , {CP, AP⁽¹⁾, . . . , AP⁽ⁿ⁾}) and to record the accuracy thereof. Then selecting the combination of the critical parameter 21 and the associated parameters 22 with a highest accuracy according to the accuracy, and recording the weights of the combination. The weights are used as combined weights of the new fault feature 40. Finally, the fault feature 40 with the highest accuracy is obtained. In general, the concepts of the method of the present invention are:

S1: screening a plurality of the initial data H collected and stored by the sensing collector to form the training parameter database 10 and the testing parameter database 20;

S2: respectively dividing the plurality of data included in the training parameter database 10 and the testing parameter database 20 into the critical parameter 11 (21) and the associated parameter candidate set 121 (221) comprising parameters other than the critical parameter 11 (21), and then identifying the plurality of associated parameters 12 leading the critical parameter 11 (21) from the associated parameter candidate set 121 (221), and sorting the plurality of associated parameters 12 from the first associated parameter to the nth associated parameter according to the leading degree; and

S3: combining the critical parameter 11 with one or more of the plurality of the associated parameters 12 from the training parameter database 10 and the testing parameter database 20 respectively to form the at least one training independent variable data and the testing independent variable data, and composing at least one fault feature 40 from the at least one training independent variable data and the fault flag by using the generalized linear model.

In summary, the fault feature can be automatically generated by the present invention, and the versatility is applicable to multiple fault prediction models, and the impact of critical parameter changes on the existing fault prediction models can be reduced. According to the present invention, it can provide more complete fault information than simply using critical parameters, and can improve the prediction accuracy of the existing model prediction.

In addition, the present invention is suitable for use in a variety of models, and there is no need to modify or develop new models as the fault prediction models in the prior art have to adapt to different equipment. The present invention has higher stability and versatility than the conventional techniques, and can avoid the problem of modifying or replacing the existing prediction models due to equipment replacement.

The equivalent constructions or modifications according to the claims still belong to the scope of the present invention.

What is claimed is:

1. An automatic optimization fault feature generation method, comprising the following steps of:
step S1: screening a plurality of data out from a plurality of initial data collected and stored by at least one sensing collector to form a training parameter database and a testing parameter database;
step S2: respectively dividing the plurality of data included in the training parameter database and the testing parameter database into a critical parameter and an associated parameter candidate set comprising parameters other than the critical parameter, and then identifying a plurality of associated parameters leading the critical parameter from the associated parameter candidate set, and sorting the plurality of associated parameters from a first associated parameter to an nth associated parameter according to a leading degree, wherein n is a positive integer; and
step S3: combining the critical parameter with one or more of the plurality of associated parameters from the training parameter database and the testing parameter database respectively to form at least one training independent variable data and at least one testing independent variable data, and composing at least one fault feature from the at least one training independent variable data and a fault flag by using a generalized linear model.

2. The automatic optimization fault feature generation method as claimed in claim 1, wherein the step S3 further comprises constructing and generating weights of the critical parameter and the plurality of associated parameters in the at least one training independent variable data according to the plurality of data included in the training parameter database.

3. The automatic optimization fault feature generation method as claimed in claim 1, wherein after the step S3, the automatic optimization fault feature generation method further comprises a step S4 of analyzing the at least one testing independent variable data by a classification method to evaluate an accuracy of the at least one fault feature.

4. The automatic optimization fault feature generation method as claimed in claim 1, wherein the generalized linear model is a logistic regression model.

5. The automatic optimization fault feature generation method as claimed in claim 1, wherein each of the plurality of initial data in the step S1 is a cycle data having a record from installation to fault occurrence.

6. The automatic optimization fault feature generation method as claimed in claim 1, wherein the fault flag is a normal operation or a fault record generated at a time point.

7. The automatic optimization fault feature generation method as claimed in claim 1, wherein the at least one fault feature is a probability value between 0% and 100%.

8. An automatic optimization fault feature generation method, comprising the following steps of:
collecting a plurality of initial data having a cycle data by at least one sensing collector to form an initial database having a plurality of data, and dividing the plurality of data into a training data set and a testing data set according to the cycle data;
screening the training data set and the testing data set by a feature extraction algorithm to form a training parameter database and a testing parameter database;
dividing the plurality of data included in the training parameter database and the testing parameter database respectively into a critical parameter set including at least one critical parameter and an associated parameter candidate set comprising parameters other than the at least one critical parameter;
identifying a plurality of associated parameters leading the at least one critical parameter from the associated parameter candidate set to form an associated parameter set;
sorting the plurality of associated parameters of the associated parameter set according to a leading degree to obtain a sorted associated parameter set; and
composing a fault feature with a fault flag, the critical parameter set and the sorted associated parameter set by using a generalized linear model.

9. The automatic optimization fault feature generation method as claimed in claim 8, wherein after composing the fault feature, the automatic optimization fault feature generation method further performs a classification accuracy evaluation to verify an accuracy of the fault feature.
